(19) United States
(12) Patent Application Publication
(10) Pub. No.: US 2008/0094748 A1
(43) Pub. Date: Apr. 24, 2008

(54) Top disk-damper imbedded hard disk drive

(76) Inventors: Yun-Sik Han, Cupertino, CA (US); Joseph Chang, San Jose, CA (US); Myeong Eop Kim, Sunnyvale, CA (US); Haesung Kwon, San Jose, CA (US); Hyung Jai Lee, Cupertino, CA (US)

Correspondence Address: IRELL & MANELLA LLP, 840 NEWPORT CENTER DRIVE, SUITE 400, NEWPORT BEACH, CA, 92660, US

(21) Appl. No.: 11/586,019

(22) Filed: Oct. 24, 2006

(51) Int. Cl. G11B 33/14

(52) U.S. Cl. 360/97.03; 360/97.02

(57) ABSTRACT

A hard disk drive that at least one disk that is rotated by a spindle motor. The rotating disk creates a flow of air within the disk drive. A damper is located adjacent to the disk. The damper reduces the velocity of the air flow and any vibration associated with the flow of air.

### BACKGROUND OF THE INVENTION

1. Field of the Invention

The present invention relates to a damper that damps vibration within a hard disk drive.

2. Background Information

Hard disk drives contain a plurality of magnetic heads that are coupled to rotating disks. The heads can magnetize and sense the magnetic fields of the disk to write and read data, respectively. The heads are coupled to a pivoting actuator arm that has a voice coil motor.

Data is stored on concentric tracks across the surfaces of the drive. The voice coil motor can move the heads to different tracks. Each track typically contains servo information that is read and used by a servo routine of the drive to maintain the heads on the centers of the tracks.

The disks are rotated by a spindle motor. The rotation of the disks creates a flow of air within the disk drive. The flow of air cooperates with air bearing surfaces of the heads to create air bearings. The air bearings prevent or minimize contact and corresponding wear between the heads and the surfaces of the disks.

The flow of air can create vibration within the drive. Vibration can caused unwanted movement of the heads. The vibration must either be attenuated, or compensated for by the servo of the disk drive. The vibration can be attenuated with dampers placed within the drive. For example, a viscoelastic damping material can be integrated into the drive housing, spindle motor assembly, etc. Additionally, the servo can incorporate filters to filter out low frequency vibrations.

To increase disk drive capacity it is desirable to increase the track per inch (“TPI”) density of the disks. TPI is dependent on track mis-registration (“TMR”) which is dependent on vibration among other factors. It would be desirable to provide a damper that can reduce the amount of vibration to allow for greater TPI and resultant capacity of a hard disk drive.

### BRIEF SUMMARY OF THE INVENTION

A hard disk drive with a disk that is rotated by a spindle motor to create a flow of air. Adjacent to the disk is a damper that reduces the velocity of the air flow.

### BRIEF DESCRIPTION OF THE DRAWINGS

FIG. 1 is a top view of an embodiment of a hard disk drive;

FIG. 2 is a cross-sectional view of the hard disk drive;

FIG. 3 is a perspective view of a damper plate;

FIG. 4 is an illustration of a damper that has a plurality of arms.

### DETAILED DESCRIPTION

Disclosed is a hard disk drive that includes at least one disk that is rotated by a spindle motor. The rotating disk creates a flow of air within the disk drive. A damper is located adjacent to the disk. The damper reduces the velocity of the air flow and any vibration associated with the flow of air.

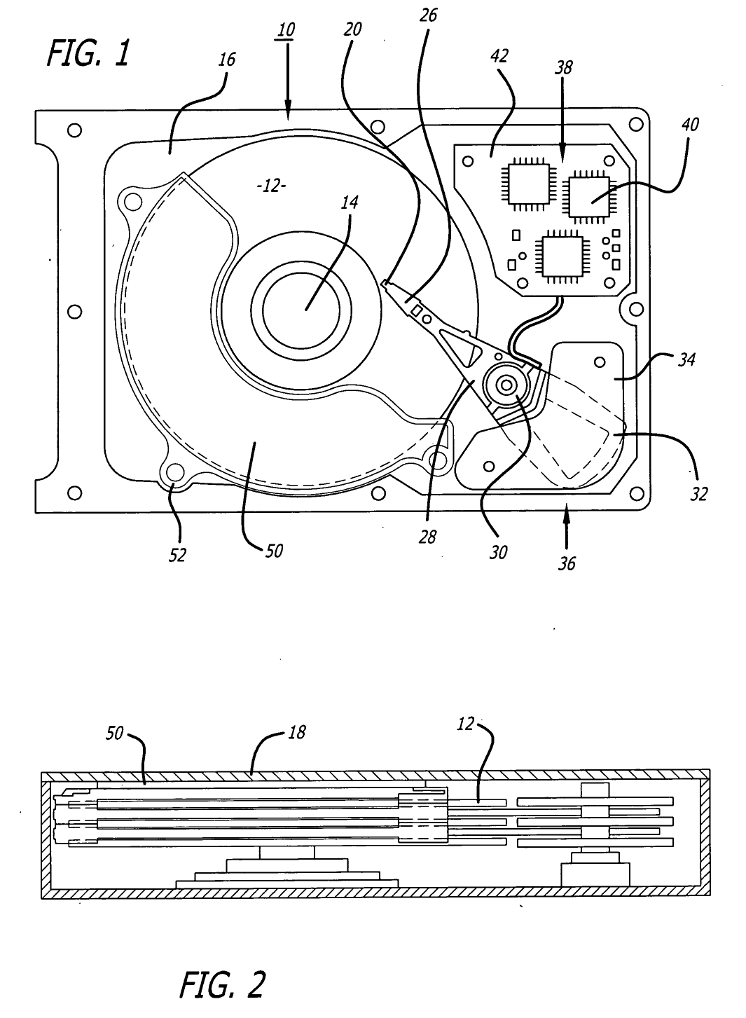

Referring to the drawings more particularly by reference numbers, FIGS. 1 and 2 show an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

During operation of the disk drive 10 the spindle motor 14 rotates the disks 12. The rotation of the disks 12 creates a flow of air within the drive.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

The drive 10 includes a damper 50 that is located adjacent to the disk 12. The damper 50 is preferably shaped and located within the disk drive 10 so as to not interfere with movement of the actuator arm 28.

The damper 50 is located a specified distance from a disk surface to reduce the velocity of the air flow within the drive. Vibration caused by the flow of air is proportional to the velocity of the air. Reducing the velocity of the air produces a corresponding reduction in vibration within the disk drive. By way of example, the distance between the damper 50 and disk surface should be no greater than 0.5 millimeters.

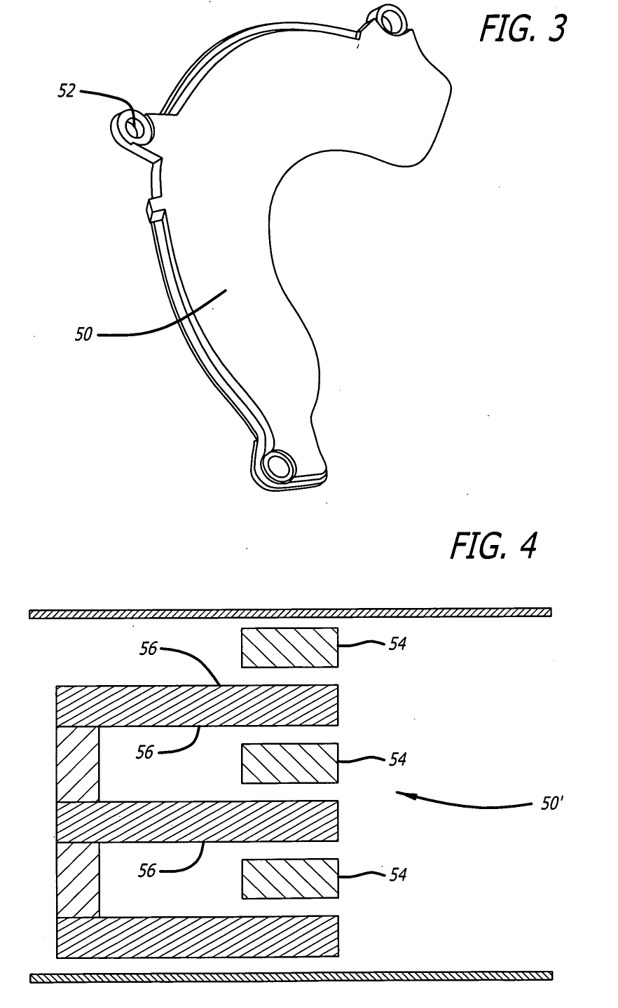

FIG. 3 shows an example of a damper 50. The damper 50 can be a plate with thru holes 52 that allow for attachment to the cover 18 of the drive. The damper plate 52 is preferably constructed from a plastic material, but may be made from other materials. To minimize the impact on the disk drive profile the damper plate 52 can be attached to an embossed area of the cover without using fasteners. The damper plate 52 and embossed cover can have matching ridges and grooves that attach the two components.

FIG. 4 shows an alternate embodiment wherein the damper 50′ has a plurality of arms 54. Each arm 54 is located adjacent to a disk surface 56. The arms 54 reduce the velocity of the air flow and corresponding vibration within the drive. By way of example, the space between each damper arm 54 and an adjacent disk surface 56 should not exceed 0.5 millimeters.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate;
a disk;
a spindle motor that is mounted to said base plate and rotates said disk to create a flow of air;
a head coupled to said disk;
an actuator arm coupled to said head;
a voice coil motor coupled to said actuator arm;
a cover attached to said base plate to enclose said disk, said spindle motor, said head and said actuator arm; and,
a damper located to said disk to reduce a velocity of the air flow.

2. The disk drive of claim 1, wherein said damper includes a plate attached to said cover.

3. The disk drive of claim 1, wherein said damper is a plate constructed from a plastic material.

4. The disk drive of claim 1, further comprising a plurality of disks and said damper includes a plurality of arms that are located adjacent to said disks to reduce the velocity of the air flow.

5. The disk drive of claim 1, wherein said damper and said disk are separated by a space no greater than 0.5 millimeters.

6. The disk drive of claim 1, wherein said damper is attached to an embossed area of said cover.

7. A hard disk drive, comprising:
a base plate;
a disk;
a spindle motor that is mounted to said base plate and rotates said disk to create a flow of air;
a head coupled to said disk;
an actuator arm coupled to said head;
a voice coil motor coupled to said actuator arm;
a cover attached to said base plate to enclose said disk, said spindle motor, said head and said actuator arm; and,
damper means for reducing a vibration caused by the flow of air.

8. The disk drive of claim 7, wherein said damper means includes a plate attached to said cover.

9. The disk drive of claim 7, wherein said damper includes a plate constructed from a plastic material.

10. The disk drive of claim 7, further comprising a plurality of disks and said damper means includes a plurality of arms that are located adjacent to said disks to reduce a velocity of the air flow.

11. The disk drive of claim 7, wherein said damper and said disk are separated by a space no greater than 0.5 millimeters.

12. The disk drive of claim 7, wherein said damper means is attached to an embossed area of said cover.

13. A method for reducing a vibration caused by air flow within a hard disk drive, comprising:
rotating a disk to create a flow of air; and,
providing a damper located adjacent to the disk that reduces the velocity of the air flow.

14. The method of claim 13, further comprising providing a damper adjacent to a plurality of disks to reduce the velocity of the air flow.
